(19) United States
(12) Patent Application Publication
(10) Pub. No.: US 2024/0342710 A1
(43) Pub. Date: Oct. 17, 2024

(54) Device, in Particular Microfluidic Cartridge, and Method, Comprising a Removal Chamber and a Removable Cover

(71) Applicant: Robert Bosch GmbH, Stuttgart (DE)

(72) Inventors: Sonja Knies, Rutesheim (DE); Daniel Sebastian Podbiel, Rutesheim (DE)

(21) Appl. No.: 18/701,050

(22) PCT Filed: Jun. 9, 2022
(86) PCT No.: PCT/EP2022/065634

§ 371 Date: Jun. 5, 2024

(30) Foreign Application Priority Data
Oct. 13, 2021 (DE) 10 2021 211 549.7

(51) Int. Cl. B01L 3/00

(52) U.S. Cl. CPC B01L 3/502723; B01L 3/502707; B01L 2200/0684; B01L 2200/12; B01L 2300/041; B01L 2400/0457; B01L 2400/0638

(57) ABSTRACT

A microfluidic device includes a removal chamber connected to a supply channel and a removal opening for removing fluid from the microfluidic device. The removal opening is closed by a removable cover provided as an adhesive film.

### PRIOR ART

Microfluidic analysis systems, also known as lab-on-chips (LoC for short), enable automated, reliable, fast, compact and cost-effective processing of patient samples for medical diagnostics. By combining a variety of operations for the controlled manipulation of fluids, complex molecular diagnostic test sequences can be performed in a lab-on-chip cartridge, which is also referred to below as a microfluidic device. Lab-on-chip cartridges, for example, can be produced cost-effectively from polymers using series production methods such as injection molding, punching or laser transmission welding.

An important requirement for a lab-on-chip cartridge is the contamination-free and safe analysis of a sample. For this purpose, such cartridges are usually designed to be fluid-tight, apart from vent openings, so that the sample can be processed in the cartridge without contamination once it has been inserted. In a large number of applications, a fully automated sample-to-answer analysis of a sample substance is carried out within the cartridge, wherein the sample substance remains enclosed in the cartridge after an analysis has been carried out. A fluid-tight enclosure of the sample liquid by the cartridge is particularly advantageous in such applications, for example to prevent unwanted leakage of amplified sample material from the lab-on-chip cartridge after the analysis has been performed.

In addition to sample-to-answer analysis of sample substances, lab-on-chip cartridges are also suitable for pure extraction and/or amplification of sample material, for example, which is then further analyzed using additional laboratory equipment after processing within the cartridge. For such applications, the most convenient, simple, safe, complete and standardized removal of a sample liquid from a cartridge is required. The particular challenge here is that, on the one hand, fluid-tight processing must take place within the microfluidic device and, on the other hand, the sample liquid must be removed from the microfluidic device as easily as possible. It should be possible to remove the sample liquid in a defined manner using a standard pipette, for example. Furthermore, it should also be possible to remove as much of the sample liquid as possible from the microfluidic device, i.e., the dead volume of sample liquid remaining in the microfluidic device that is not accessible when a sample is removed should be as small as possible.

### DISCLOSURE OF THE INVENTION

### Advantages of the Invention

Against this background, the invention relates to a device with a removal chamber. The removal chamber is connected to a supply channel and has a removal opening for removing fluid from the device, in particular from the removal chamber, wherein the removal opening is closed with a removable cover.

In particular, the device can be a microfluidic device, also known as a lab-on-chip cartridge (LoC for short), for example a microfluidic cartridge as described, for example, in DE 10 2016 222 075 A1 or DE 10 2016 222 072 A1.

The removal chamber is preferably connected to other fluidic elements, in particular channels and/or chambers, via the supply channel and can be filled with fluid from these elements. For example, these other elements are part of a fluidic network to which the removal chamber is connected via the supply channel.

A removable cover is to be understood in particular as a cover which can be removed from the removal opening without destruction, in particular without the use of aids, and in particular thus makes the removal opening accessible, i.e., in particular without damaging the cover or the removal opening. The cover can preferably be an adhesive film, i.e., a film made of plastic or composite material, for example, wherein one side of the film has an adhesive for adhering the film to the device. By using a film to close the removal opening, both a reliable sealing of the removal chamber during the processing of the device within an analyzer or processing device can be achieved, as well as an easy opening of the removal chamber. In an advantageous embodiment, the adhesive film has a tab that enables the user to remove the adhesive film in a particularly simple and defined manner. Compared to closing the removal chamber with a screw-on lid, a film-based closure solution such as the adhesive film is particularly cost-effective and can be implemented with a small removal opening at a reasonable production cost, as in particular no thread is required to close the removal opening. In an alternative embodiment, the cover can also be a closure, in particular a lid, which can be attached to the device, for example via a positive connection such as a thread in the lid or a latching lug. The cover is therefore preferably a fluid-tight, at least liquid-tight closure for the removal opening of the removal chamber.

The device according to the invention has the advantage that it allows, in particular, manual removal of a sample liquid from the device via the removal chamber after it has been processed in the device, wherein the removal is simple, safe and almost complete. Due to the removable cover, the risk of contamination of both the environment and the interior of the device by the environment is also advantageously significantly reduced despite the removal opening.

The invention can advantageously significantly extend the range of applications of a microfluidic device in particular. In particular, in addition to a fully automated sample-to-answer analysis of a sample substance within the device, it is also possible, for example, only to purify a sample substance, for example by extracting sample material or certain species from the sample substance and/or only to amplify sample material within the device. The sample liquid obtained by extraction and/or amplification within the device, for example, can then be further analyzed using other external analysis devices after removal from the microfluidic device. In an external analyzer, for example, amplification and fluorometric detection of DNA present in the sample liquid can be carried out using a PCR cycler and/or gel electrophoresis can be carried out and/or sequencing of DNA material present in the sample liquid can be carried out. In this way, the approach presented here, using a device according to the invention with a removal chamber, creates a variety of new application possibilities for a microfluidic lab-on-chip system, which result in particular from a combined processing of a sample substance within the microfluidic device on the one hand and using further specialized laboratory devices, for example for molecular diagnostic sample analysis, on the other.

In a particularly advantageous further development of the invention, the removal chamber is connected to a discharge channel or vent channel. Fluid can be discharged from the removal chamber via the discharge channel or vent channel when filling through the supply channel, so that pressure equalization is advantageously ensured.

Preferably, the removal chamber or the vent channel has a vent opening to surroundings outside the device, wherein the vent opening is preferably closed with a further cover. As with the cover for the removal opening, the additional cover can be an adhesive film or a lid. In a particular embodiment, the cover of the removal opening also closes the vent opening, so that both openings are advantageously exposed at the same time when the cover is removed. Such a vent opening has the advantage of venting the removal chamber when fluid is removed, which in particular can prevent the development of negative pressure in the removal chamber, which can be a hindrance to controlled fluid removal.

According to an advantageous embodiment, the supply channel and/or the discharge channel can be separated from the other fluidic elements, in particular from the microfluidic network, via a valve, for example a membrane-based microfluidic valve or a geometric microfluidic valve, in particular a passive structural element, which provides a valve functionality (until the maximum capillary pressure built up at the element is exceeded) due to the surface tension of a liquid present at a phase interface. In this way, unwanted penetration of other fluid from the microfluidic network into the removal chamber can be advantageously prevented, especially if there is still sample liquid to be removed in the removal chamber. In a preferred embodiment, the device is set up to close these valves in the supply channel and/or discharge channel after the removal chamber has been filled with fluid to be withdrawn, for example after processing of the device has been completed, for example after the device has been processed in an analyzer. This has the advantage that the sample liquid to be removed from the removal chamber cannot be contaminated with another liquid that may be present in the microfluidic network.

In a special embodiment, the device, in particular the microfluidic network, comprises a liquid receiving capacity, for example a liquid receiving reservoir, for example in the form of a chamber. This has the advantage that fluid, in particular liquid, can be intercepted from the device, in particular from the microfluidic network, and prevented from penetrating the removal chamber undesirably. For this purpose, the liquid receiving capacity can, for example, have a valve for closing off the capacity to the removal chamber.

According to a particularly preferred embodiment of the invention, the removal opening is arranged in an end region of the removal chamber, wherein the end region preferably comprises one third, most preferably one fifth of the removal chamber or alternatively of the volume of the removal chamber. This has the advantage that fluid, especially liquid, can be removed via one end of the chamber and thus as completely as possible from the removal chamber. Preferably, the end region forms a lowermost region of the chamber in relation to the intended orientation or use of the device. In other words, the end region is the lowest region of the chamber and comprises the removal opening. This has the advantage that the fluid, in particular the liquid, collects in this end region due to gravity when the device is used as intended and can therefore be removed as completely as possible via the removal opening in a simple manner. Another particular advantage is that liquid volumes of different sizes can be easily and reliably removed from the removal chamber, as they are always located at the lower end of the removal chamber.

Preferably, the removal chamber has a non-rotationally symmetrical shape, in particular an elongated shape, for example an oval shape or a cuboid shape with a rectangular and at least one non-square cross-section. A long side of the removal chamber is preferably aligned with the gravitational field in the device in such a way that at least one non-vanishing component of the gravitational field acts along this long side. Furthermore, as described above, the removal opening is preferably located at the lower end or in the lower end region of the removal chamber. In this way, as explained above, the force of gravity acting on the liquid in the removal chamber can be used to cause the liquid to accumulate at the lower end of the removal chamber. Accordingly, liquid can be removed from the removal chamber in a particularly simple and controlled manner via the removal opening located there.

In an advantageous embodiment, the removal chamber has a rounded shape. In particular, this means that the rounded region of the chamber has no edges or corners. This advantageously prevents fluid residues, especially liquid, from being difficult to remove from these edges and corners and thus remaining there. In other words, the removal chamber or an interior of the removal chamber has a rounding. In particular, the removal chamber can have a rounded shape or rounding in the end region, preferably in the entire interior of the removal chamber.

According to a particularly advantageous further development, the supply channel opens into the end region of the removal chamber. This has the advantage that fluid, in particular liquid, can be introduced directly into the end region of the removal chamber.

Another object of the invention is a method for removing a fluid from a device according to the invention. In a first step of the method, fluid to be removed, in particular liquid, is introduced into the removal chamber via the supply channel, in particular from the fluidic network. In a second step, the cover is removed to expose the removal opening. Preferably, the vent opening is also released or the additional cover is removed. In a third step, at least part of the fluid is removed from the removal chamber through the removal opening. The removal is preferably carried out with the device inclined in the gravitational field of the earth, so that the fluid to be removed, in particular the liquid to be removed, is at least partially located in an end region of the removal chamber, wherein the end region comprises the removal opening.

With regard to the advantages of the method according to the invention, reference is also made to the above-mentioned advantages of the device according to the invention.

### BRIEF DESCRIPTION OF THE DRAWINGS

Exemplary embodiments of the invention are shown schematically in the drawings and explained in more detail in the description hereinafter. Like reference signs are used for elements illustrated in the various drawings having a similar effect, wherein a repeated description of the elements has been omitted.

### Shown are:

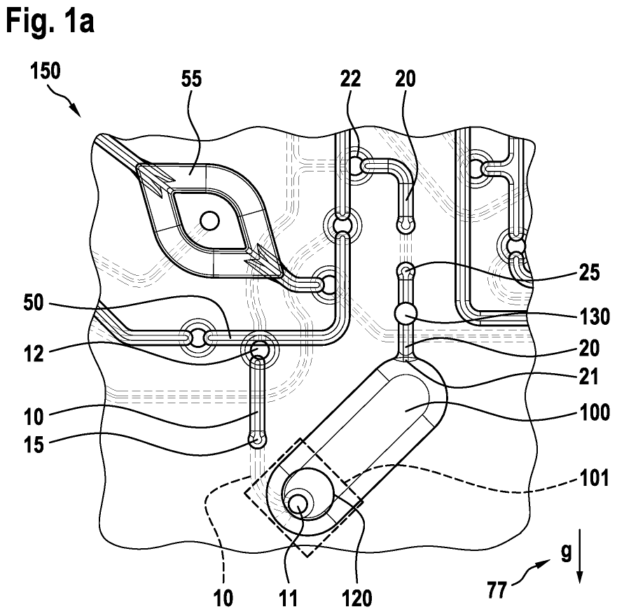

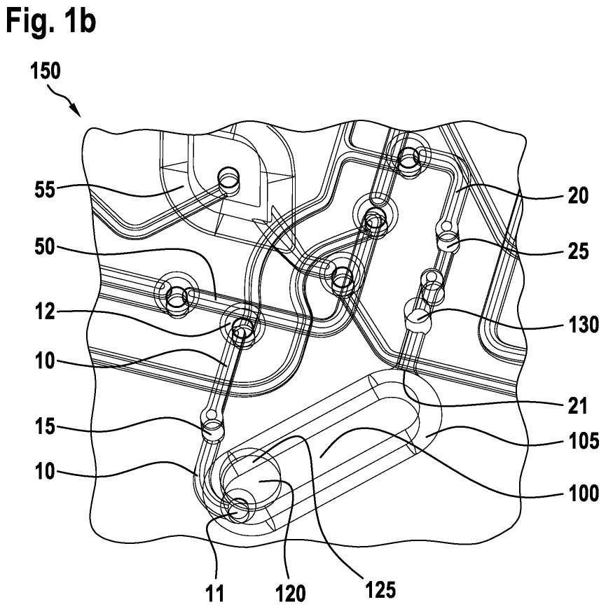

FIGS. 1-3 exemplary embodiments of the device according to the invention and

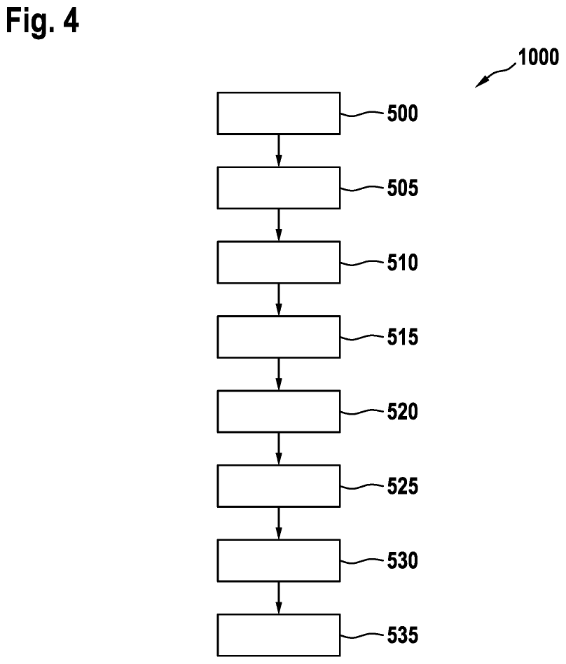

FIG. 4 a flow diagram of an exemplary embodiment of the method according to the invention for removing a fluid from a device according to the invention and

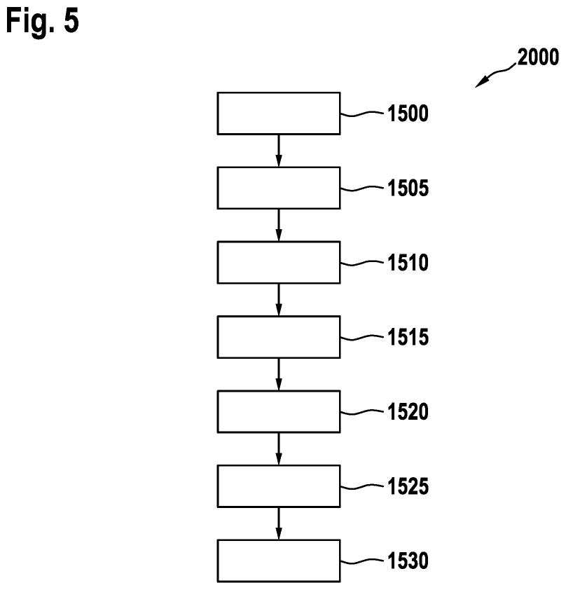

FIG. 5 a flow diagram of an exemplary embodiment of the method according to the invention for producing a device according to the invention

### EMBODIMENTS OF THE INVENTION

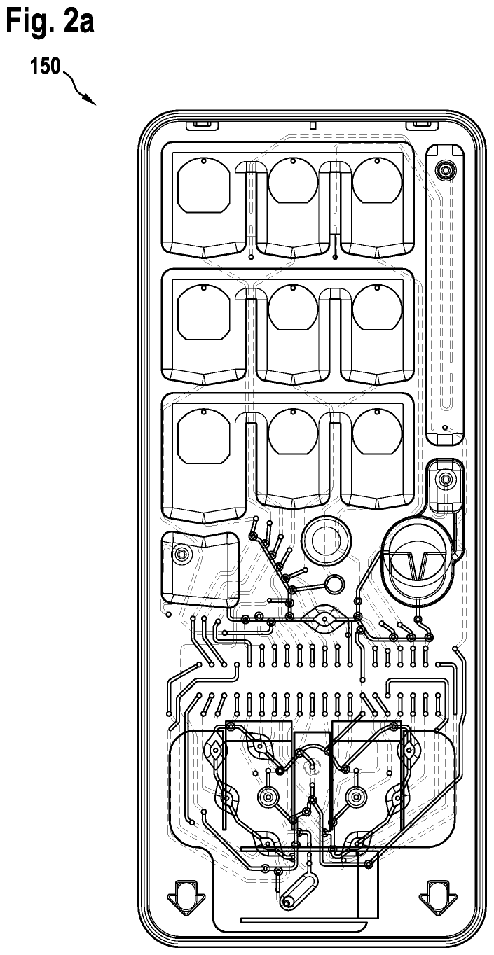

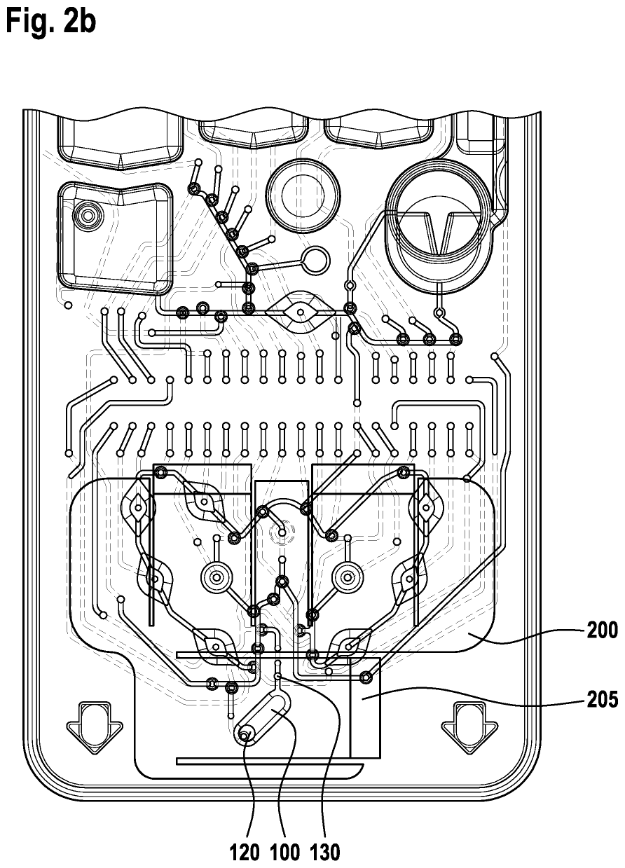

FIGS. 1a and 1b show sections of two schematic representations of an exemplary embodiment of the device 150 according to the invention with removal chamber 100 from two different perspectives, in FIG. 1a as a vertical plan view and in FIG. 1b slightly enlarged with respect to FIG. 1a as a slightly oblique perspective view. In this example, the device 150 is a microfluidic device, also known as a lab-on-chip device, for example a lab-on-chip cartridge, which can be processed in an analyzer, as described for example in DE 10 2016 222 075 A1 or DE 10 2016 222 072 A1. A cover, preferably an adhesive film 200, which can be used to seal the removal opening 120 and preferably a vent opening 130, is not shown here for the sake of simplicity and is described in connection with FIG. 2.

The preferably elongated removal chamber 100 is connected to a microfluidic network 50 of the device 150 via a supply channel 10 and a discharge channel or vent channel 20, which enables sample liquid to be introduced into the removal chamber 100, for example by means of a pump chamber 55.

The removal of liquid from the removal chamber 100 takes place in particular via the removal opening 120, wherein the additional vent opening 130 of the discharge or vent channel 20 can be used to vent the removal chamber 100 during the removal of a liquid through the removal opening 120.

The removal opening 120 is located in an end region 101, wherein the end region comprises, for example, one third of the chamber 100, in particular at the lower end of the removal chamber 100 as well as an opening 11 of the microfluidic supply channel 10 into the chamber 100, in order to enable removal of small volumes of liquid from the removal chamber 100 through the removal opening 120, for example by pipetting.

Furthermore, the longitudinal side of the removal chamber 100 is suitably aligned with a gravitational field (g) 77, such as the gravitational field of the earth, so that the liquid introduced into the removal chamber 100 via the microfluidic supply channel 10 accumulates in particular at the lower end of the removal chamber 100 in the immediate surroundings of the removal opening 120. In this exemplary embodiment, the opening 21 of the discharge or vent channel 20 is located at the highest point of the removal chamber 100 in order to enable complete filling of the removal chamber 100 through the microfluidic supply channel 10 on the one hand, and to effect (almost) complete emptying of the removal chamber 100 through the removal opening 120 using the vent opening 130 on the other. The discharge or vent channel 20 and the vent opening 130 are arranged, for example, in particular above the removal chamber 100, wherein the discharge or vent channel 20 is arranged in particular at the end of the removal chamber 100 opposite the end region 101.

In addition, the microfluidic supply channel 10 and the discharge channel 20 can each be separated from the microfluidic network 50 via a membrane-based microfluidic valve 12, 22. In particular, after removal of the microfluidic device 150 with the removal chamber 100 from an analyzer in which the device is processed, the passively acting membrane-based valves 12, 22, for example, can be used to prevent liquid from the microfluidic network 50 from penetrating the removal chamber 100 unhindered.

Furthermore, the microfluidic supply channel 10 and the discharge channel 20 have vias 15, 25, i.e., connecting sections between different levels of the device in which the channels are implemented, so that a siphon-shaped channel routing of the supply channel 10 and the discharge channel 20 is realized in each case. While the advantageous design of the microfluidic supply channel 10 in this way allows the removal chamber 100 to be filled from the lowest point, the siphon of the microfluidic discharge channel 20 can in particular delay any undesired penetration of liquid into the removal chamber 100 from the microfluidic network 55 via the microfluidic discharge channel 20.

Furthermore, the removal chamber 100 has a rounding 105, which prevents the formation of undesirable liquid inclusions—as can occur in particular at the corners of microfluidic structures—and thus allows the liquid removal chamber to be emptied as completely as possible.

On the other hand, in the advantageous embodiment shown, the removal opening 120 in particular has no (appreciable) rounding in order to utilize the pinning of a liquid occurring at the edge 125 thus present in order to prevent undesired wetting of the upper side of the microfluidic device 150 with the liquid to be removed—in particular when the adhesive film is removed.

FIGS. 2a and 2b show two schematic representations of a further exemplary embodiment of the device 150 according to the invention with applied cover 200, wherein it can basically be the same embodiment as in FIGS. 1a and 1b. In contrast to FIGS. 1a and 1b, FIGS. 2a and 2b each show a top view of the entire microfluidic device 150 (FIG. 2a) or a larger section of the microfluidic device 150 (FIG. 2b). The device 150 again comprises a removal chamber 100 connected to a fluidic network 50 and, for example, a structured adhesive film 200 with peel-off tabs 205 as cover 200 which is bonded thereto and serves to reversibly seal the removal opening 120 and the vent opening 130.

By means of the adhesive film 200 applied to the microfluidic device 100, reliable sealing of the openings 120 and 130 can initially be achieved, for example during processing of the microfluidic device 100 in an analyzer. For example, a thermostable sealing of the microfluidic cartridge 150 up to temperatures of 95° C. is also achieved by means of the adhesive film 200, so that, for example, a thermally initiated amplification reaction such as a polymerase chain reaction can be carried out in the microfluidic device 150. After processing the microfluidic device 150 in the analyzer, the adhesive film 200 can be easily peeled off using the peel-off tab 205, at least in subregions, to allow liquid removal through the liquid removal opening 120. When the adhesive film 200 is removed, the vent opening 130, which is advantageous for manually emptying the removal chamber 100, is also exposed.

An important aspect to prevent unwanted contamination of sample liquid present in the removal chamber 100 with a system liquid of the microfluidic network 50 is the implementation of a passive microfluidic separation of the liquid removal chamber 100 from the microfluidic network 50. During processing of the microfluidic device 150 in the analyzer, the removal chamber 100 can be separated, for example, via active pneumatically actuated membrane-based valves 12, 22 (see FIGS. 1a and 1b). However, once the microfluidic device 150 has been removed from the analyzer, active control of the pneumatic valves 12, 22 in particular is no longer possible without further ado. This raises the question of how to provide a purely passive functionality that ensures a microfluidic separation of the removal chamber 100 from the microfluidic network 50. One possibility for passive microfluidic separation of the liquid removal chamber 100 from the microfluidic network 50 is through the use of membrane-based valves 12, 22, in which the membrane rests on a valve web in the depressurized state in order to prevent flow through the valve 12, 22. Another possibility to realize a passive separation functionality is given by so-called geometric microfluidic valves, where it is exploited that the capillary pressure, which is present at a microfluidic phase interface, correlates with the radius of curvature of the microfluidic phase interface, as described by the Young-Laplace equation. Accordingly, for example, an abrupt tapering of the cross-sectional area of a microfluidic channel can result in pinning of a phase interface at the edge of the channel taper and the small channel cross-section leads to a high capillary pressure of the phase interface in the region of the channel taper, which must first be overcome in order to induce penetration of liquid into the region of the microfluidic channel behind it.

Furthermore, in addition to a purely microfluidic separation of the removal chamber 100 from the microfluidic network 50, it is also possible to use a liquid receiving chamber, i.e., a liquid capacity at the lower end of the microfluidic network, which is intended in particular for receiving liquid that flows to the lowest point of the microfluidic network, for example driven by gravity.

In the following, the individual measures for passive microfluidic separation of the removal chamber 100 from the microfluidic network 40 are described in more detail and quantitatively in order to illustrate their technical mode of action.

As a relevant comparative value for assessing the pressure conditions that may be present within the microfluidic device 150 after removal of a microfluidic device 150 from the analyzer, for example, the gravitational liquid pressure that can build up to a maximum in the microfluidic device 150 can be used. This is p=F/A=mg/A=p V g/A=ph g, wherein p is the pressure, F is the weight force on the liquid, A is a cross-sectional area of a channel, m is the mass of the liquid, g is the gravitational acceleration in the Earth's gravitational field, p is the density of the liquid, V is the volume of the liquid and h is the height of a column of liquid in the microfluidic device 150. For a density of an aqueous solution of approximately p=10³ kg/m³ and a gravitational acceleration in the Earth's gravitational field of approximately g=10 m/s², this results in a gravitational liquid pressure p as a function of the height h of a liquid column of p=1 mbar×h/cm. This means that for a microfluidic device with a height of, for example, h=20 cm, the maximum possible gravitational liquid pressure is approximately p=20 mbar.

The capillary pressure Δp, which can build up at the channel taper of a geometric microfluidic valve, correlates directly with the surface tension γ of the liquid and the radius of curvature R of the interface according to the Young-Laplace equation. The radius of curvature R of the interface generally depends on the width or diameter 2a of the microfluidic channel as well as the contact angle θ of the liquid:

$$Δ p = 2 γ / R = 2 γ / a * cos ( θ ) .$$

For water, for example, the surface tension at 20° C. is γ=0.0728 J/m². Assuming a contact angle of θ=90°, as can be approximated on non-polar polymer surfaces in particular, this results in a capillary pressure of

$$Δ p = 0.15 / a Pa / m = 15 mbar / ( a / 100 µm ) ,$$

wherein a in this case describes the radius of the microfluidic channel at the point of maximum taper. With a minimum channel diameter of 2a=200 μm, the existing capillary pressure is therefore 15 mbar, whereas with a channel diameter of 2a=100 μm it is already 30 mbar. Consequently, by implementing a sufficient tapering of the microfluidic channel, a capillary pressure can be built up, if necessary, which exceeds the gravitational liquid pressure and thus prevents liquid from passing through the geometric microfluidic valve. However, it should be noted that the surface tension γ of the liquid can be reduced by adding detergents to an aqueous solution, for example, or by changing the temperature, so that the capillary pressure, which can build up at the geometric valve, is also reduced accordingly. In order to be less dependent on the surface tension γ of the liquid, the use of a membrane-based valve, as described below, is therefore particularly suitable for the realization of a passive microfluidic separation functionality.

In a membrane-based microfluidic valve, the passive sealing functionality results from the restoring force of a deflection of an elastic membrane caused by hydraulic pressure, which causes the valve to seal when depressurized. Preferably, the valve membrane is not preloaded when the pneumatic valve is depressurized. Such a valve can, for example, correspond to one of the microfluidic valves 12, 22, which are present in the embodiment shown in FIG. 1. The counterpressure that can be exerted by the elastic membrane on a liquid under hydraulic pressure depends not only on the geometric dimensions of the microfluidic valve, but also on the modulus of elasticity of the membrane and its flow behavior under mechanical stress. By using an elastic membrane with a sufficiently large modulus of elasticity of, for example, several 10 MPa and a sufficiently small valve diameter in the range of 1 mm, the liquid path released by the membrane can be limited to a cross-sectional area with a height of approximately h=100 μm (deflection of the elastic membrane) times a width of b=1 mm (diameter of the valve) at a hydraulic pressure of several 10 mbar, for example. Consequently, a leakage volume flow dV/dt through this liquid path can be estimated according to the Hagen-Poisseuille law under the approximation that the height h is significantly smaller than the width b, i.e., h<<b and can therefore be assumed for the constant K=1, as follows:

$$dV / dt = 1 / ( 12 η l ) {h}^{3} bp .$$

For water with a dynamic viscosity of η=1 mPa s, the estimate for the maximum leakage volume flow through such a valve with h=100 μm, b=1 mm, 1=1 mm is: dV/dt˜10∧(−4) μl/s p/mbar=1 μl/3 h p/mbar. Accordingly, the leakage volume flow dV/dt according to this estimate is a few microliters per hour, depending on the existing hydraulic pressure p. This value appears to be sufficiently low so that—even if a liquid is removed from the liquid removal chamber 100 with a time delay of several minutes—a volume of liquid flowing through a microfluidic separation valve 12, 22 due to an existing gravitational liquid pressure is sufficiently low to prevent undesired dilution of the sample liquid present in the removal chamber 100 with system liquid.

The observations thus show that such passive safety measures can make a decisive contribution to avoiding contamination of the sample liquid present in the removal chamber 100, but are ultimately subject to certain limitations in principle.

For this reason, it is particularly advantageous to actively pump the system liquid present in the microfluidic network as completely as possible into a liquid receiving chamber before removing the microfluidic device 150 from the analyzer (also called processing device), so that the volume of liquid in the microfluidic network 50, which can lead to potential contamination of the sample liquid in the removal chamber 100, is significantly reduced. Furthermore, by reducing the volume of liquid present in the microfluidic network 50, the build-up of hydraulic pressure in the microfluidic network 50 due to external influences such as gravity or other accelerations can in principle be minimized.

Such a particularly advantageous procedure is also described in the following exemplary embodiment of the method for using a device 150 according to the invention. The core of the method according to the invention comprises three steps. First, fluid to be removed, in particular liquid, is introduced into the removal chamber 100 via the supply channel, in particular from the fluidic network 50. The cover is then removed to expose the removal opening. Preferably, the vent opening is also released or the additional cover is removed. At least part of the fluid is then removed from the removal chamber through the removal opening.

This method may, for example, be part of a further method 1000 for processing a sample with the device 150, which is shown in FIG. 4 in the form of a flow chart.

In a first step 500 of the method 1000, a sample substance is introduced into a sample introduction chamber of the microfluidic device 150. In the second step 505, the sample input opening of the sample input chamber of the microfluidic device 150 is closed. In the third step 510, the microfluidic device 150 is fed into an analyzer or processing device, which enables processing of the sample substance within the microfluidic device 150, in particular in the fluidic network 50 of the device. In the fourth step 515 of processing and transferring, the sample substance is processed within the microfluidic device 150 and processed sample liquid is introduced into the liquid removal chamber 100 of the microfluidic device 150. When transferring processed sample liquid into the removal chamber 100, for example, a defined dilution of the sample liquid with a system liquid can take place.

In an advantageous embodiment, the sample substance is also analyzed, for example using molecular diagnostic analysis methods. In another particularly advantageous embodiment, after the sample substance has been processed in the microfluidic network 50 and the processed sample liquid has been introduced into the removal chamber 150, the liquid, which is present in further subregions of the microfluidic network 50, is at least partially pumped into a liquid storage chamber. In this way, undesired penetration of liquid into the removal chamber 100 caused, for example, by mechanical forces acting on the microfluidic device 150 can be prevented, in particular after the microfluidic device 150 has been removed from the analyzer.

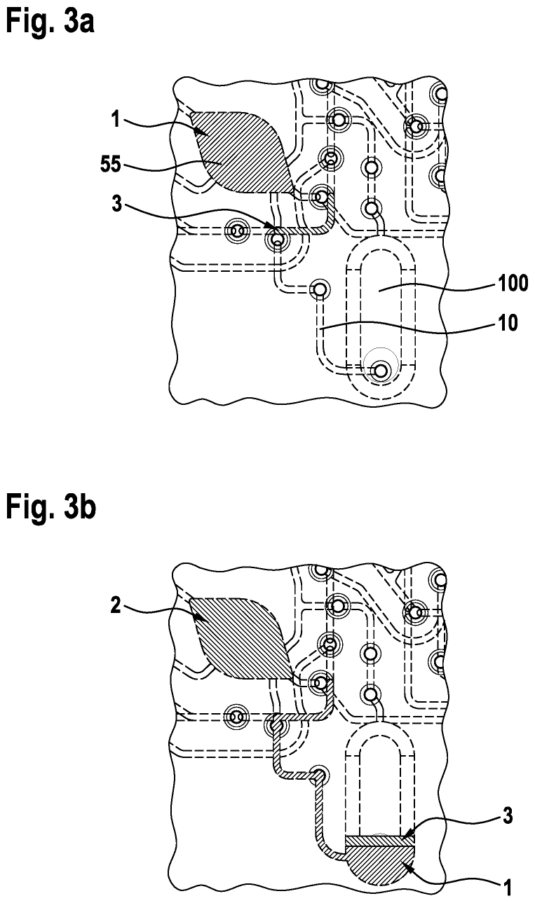

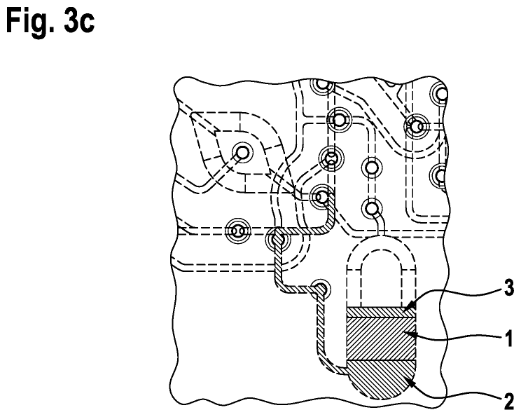

FIGS. 3a, 3b and 3c schematically illustrate an exemplary embodiment of the introduction of a processed sample liquid from the microfluidic network 50 into the removal chamber 100, exemplarily comprising a dilution of the sample liquid with a system liquid, for example a buffer. The insertion is carried out in particular by performing three sub-steps, which are shown in the three figures.

In the first sub-step (FIG. 3a), a defined volume of sample liquid 1, such as 20 μl, is present in a pump chamber 55. In the second sub-step (FIG. 3b), the sample liquid volume 1 was pumped from the pump chamber 55 into the removal chamber 100 and the pump chamber 55 was filled with a system liquid 2, for example an aqueous solution as described below. The system liquid possibly present in the channel section of the microfluidic network 50 between the pump chamber 55 and the supply channel 10 was also transferred to the removal chamber 100, so that the sample liquid in the removal chamber 100 is present in a dilution, for example a 9:10 dilution. In an alternative embodiment, no system liquid is present in the channel section between the pump chamber 55 and the supply channel 10, so that no dilution of the sample liquid occurs during transfer to the liquid removal chamber 100. In the third sub-step (FIG. 3c), the system liquid volume 2 was pumped from the pump chamber 55 into the removal chamber 100. Consequently, for example, a defined 1:2 dilution of the sample liquid 1 is now present in the removal chamber 100.

In the fifth step 520 of the method 1000, the microfluidic device 150 is removed from the analyzer and, optionally, an analysis result is also output. In the sixth step 525, a removal opening 120 of a removal chamber 100 of the microfluidic device 150 is exposed by removing the cover.

Preferably, the removal opening 120 is exposed by at least partially peeling off the structured adhesive film 200 attached to the upper side of the microfluidic device 150, for example by utilizing a peel-off tab 205. In an alternative embodiment, exposure of the removal opening 120 can be achieved by removing a lid element which seals the removal opening 120 to the external surroundings of the microfluidic device 150, for example by means of an interference fit and/or using a threaded screw cap. In another particularly advantageous embodiment, a vent opening 130 is also exposed in addition to the removal opening 120.

In the seventh step 530, at least a portion of the sample liquid present in the removal chamber 100 is removed from the removal chamber 100 via the removal opening 120. The removal is preferably carried out with the device 150 inclined in the gravitational field of the earth, so that the fluid to be removed, in particular the liquid to be removed, is at least partially located in the end region 101 of the removal chamber 100, wherein the end region comprises the removal opening 120. The sample liquid is removed, for example, by aspiration using a pipette.

In an eighth step 535 of the method 1000, the sample liquid removed from the microfluidic device 150 is further utilized. For example, the sample liquid is used for a molecular diagnostic analysis, for example by performing an amplification reaction such as a polymerase chain reaction or an isothermal amplification method and/or performing a gel electrophoresis and/or performing a sequencing of sample material. In a further development of the exemplary embodiment, the sample liquid is fed into a second microfluidic device and further processed therein.

FIG. 5 shows a flow chart of an exemplary embodiment of the producing method 2000 according to the invention.

In a first step 1500 of the method 2000, the semi-finished products or components forming the microfluidic device 150 are preferably produced separately, for example by injection molding or injection compression molding of polymer components and/or punching of polymer films.

For example, in order to ensure that the polymer components can be demolded during injection molding, the microfluidic device 150 with the microfluidic chambers and channels is composed in particular of at least two polymer components, which are provided with each other in a step 1510 of providing. Preferably, the polymer components are either transparent or absorbent at a predetermined wavelength, for example within the near infrared range (for example, by a targeted addition of carbon black particles), in order to enable the components to be joined by means of laser transmission welding in the third step 1510 described below.

In a second step 1505, at least two semi-finished products for producing a microfluidic device 150 are arranged on a workpiece carrier. The semi-finished products are, for example, flat at least in subregions and have, for example, the same or at least similar lateral dimensions. In an advantageous embodiment, the workpiece carriers have, for example, alignment pins which engage in alignment holes in the semi-finished products in order to achieve a defined positioning of the semi-finished products on the workpiece carrier and a defined relative positioning of the at least two semi-finished products to one another. The latter is used, for example, to prepare a subsequent third step 1510.

In the third step 1510, at least two semi-finished products located on a workpiece carrier are combined to form the microfluidic device 150. The availability of at least two semi-finished products can, for example, be achieved using a series production technology such as laser transmission welding. The two semi-finished products are pressed together, for example, in order to achieve good heat conduction between the at least two semi-finished products during the welding process.

In a fourth step 1515, a semi-finished product or an assembly comprising a plurality of semi-finished products for producing a microfluidic device 150 is equipped with at least one further part. The other part can be a reagent bar, for example, which is inserted into a liquid reagent holder provided for this purpose. Equipping with additional parts can be accomplished by inlaying, inserting or attaching and/or snapping, for example. In another embodiment, for example, it is a reaction bead, i.e., a freeze-dried/lyophilized solid reagent, which is introduced, for example, into a recess provided for this purpose in a semi-finished product (or an assembly of a plurality of semi-finished products) to form the microfluidic device 150. In another embodiment, for example, it is an array support element such as a hybridization array or a microcavity array that can be used to perform detection reactions in the microfluidic device 150. For example, the array support element can be bonded into the semi-finished product (or the assembly of a plurality of semi-finished products) to form the microfluidic device 150.

In a fifth step 1520, at least one of the second, third or fourth step is repeated. For example, the second, third and fourth steps 1505, 1510, 1515 are performed multiple times to form a multilayer microfluidic device 150 with inserted parts such as reagent bars or solid reagents.

In an advantageous embodiment of the method 2000, after the fourth step 1515 of placing, a second step 1505 of arranging and a third step 1510 of providing are carried out in order to enclose or provide an enclosure within the microfluidic device 150 for the parts which have been introduced in the fourth step 1515 of placing into a semi-finished product or an assembly consisting of a plurality of semi-finished products for the production of a microfluidic device 150.

In a sixth step 1525, a structured adhesive film and/or a lid element is applied as a cover. The adhesive film or lid element can be used in particular to reversibly close the removal opening 120 and, if necessary, the vent opening 130.

In a seventh step 1530 of packaging, the microfluidic device 150 is packaged in an envelope. For example, the microfluidic device 150 is packaged in an airtight sealed aluminum film (pouch) containing a dry bag to enable long-term stable packaging and storage of the microfluidic device 150.

In further embodiments of the method 2000, individual steps may be omitted and/or performed repeatedly and/or interchanged in sequence with other steps.

In the following, exemplary dimensions and specifications of realizations of the device according to the invention described in the above-mentioned exemplary embodiments are mentioned.

Volume of the removal chamber 100:
5 μl to 100 μl, preferably 20 μl to 80 μl, for example 50 μl

Size of the removal opening 120:
1 mm² to 25 mm², preferably 3 mm² to 10 mm², for example 5 mm²

Lateral outer dimensions of the removal chamber 100:
2×5 mm² to 12×60 mm², preferably 3×7 mm² to 8×15 mm², for example 4×10.5 mm²

Lateral outer dimensions of the entire microfluidic device 150:
70 mm×50 mm to 300 mm×150 mm, preferably 90 mm×60 mm to 200 mm×100 mm, for example 186 mm×78 mm

Cross-sectional dimensions of the microfluidic channels of the microfluidic network 50:
100×100 μm² to 3×3 mm², preferably 300×300 μm² to 1×1 mm², for example 600×400 mm²

Materials for the realization of the microfluidic device 150:
Primarily polymers such as polycarbonate (PC), polystyrene (PS), styrene-acrylonitrile copolymer (SAN), polypropylene (PP), polyethylene (PE), cycloolefin copolymer (COP, COC), polymethyl methacrylate (PMMA), polydimethylsiloxane (PDMS) or thermoplastic elastomers (TPE) such as polyurethane (TPU) or styrene block copolymer (TPS) manufactured using series production methods such as injection molding, injection compression molding, thermoforming, punching or laser transmission welding.

Sample liquid, which is removed from the removal chamber 100:
For example, an aqueous solution, for example obtained from a biological substance, for example of human origin, such as a body fluid, a swab, a secretion, sputum, a tissue sample or a device with attached sample material. The sample liquid contains, for example, species of medical, clinical, diagnostic or therapeutic relevance such as bacteria, viruses, cells, circulating tumor cells, cell-free DNA, proteins or other biomarkers or, in particular, components from the aforementioned objects such as DNA or RNA. For example, the sample liquid is a master mix or components thereof, for example after performing at least one amplification reaction in the microfluidic device, for example for DNA detection at the molecular level such as an isothermal amplification reaction or a polymerase chain reaction.

System liquid, which is processed in the microfluidic network 50 alongside and/or in combination with the sample liquid:

For example, an aqueous solution, such as a buffer solution, for example mixed with a detergent such as Tween; alternatively, for example, an oil, such as mineral oil, silicone oil, or a fluorinated hydrocarbon.

1. A microfluidic device, comprising:
a removal chamber connected to a supply channel and defining a removal opening for removing fluid from the microfluidic device; and
a removable cover configured to close the removal opening.

2. The microfluidic device according to claim 1, wherein the removal chamber is connected to a discharge channel or a vent channel for pressure equalization in the removal chamber.

3. The microfluidic device according to claim 1, wherein:
the removal opening is arranged in an end region of the removal chamber, and
the end region comprises one third of the removal chamber.

4. The microfluidic device according to claim 3, wherein the end region forms a lowermost region of the removal chamber with respect to an intended orientation of the microfluidic device.

5. The microfluidic device according to claim 1, wherein the removal chamber has a non-rotationally symmetrical shape.

6. The microfluidic device according to claim 3, wherein the removal chamber has a rounded shape in the end region.

7. The microfluidic device according to claim 2, further comprising:
one or more valves configured to isolate the supply channel, the discharge channel, and/or the vent channel,
wherein the one or more valves are membrane-based or geometric valves.

8. The microfluidic device according to claim 2, wherein the vent channel comprises a vent opening operably connected to surroundings outside the device.

9. The microfluidic device according to claim 8, wherein the vent opening is closed with the removable cover.

10. A method for removing a fluid from a microfluidic device, comprising:
introducing a fluid into a removal chamber of the microfluidic device via a supply channel of the microfluidic device that is connected to the removal chamber;
removing a removable cover of the microfluidic device to expose a removal opening defined by the removal chamber, the removable cover configured to close the removal opening when connected to the removal opening; and
removing at least part of the fluid from the removal chamber through the removal opening.

11. The method according to claim 10, wherein:
the removal takes place with the microfluidic device inclined in a gravitational field of the earth, so that the fluid to be removed is at least partially located in an end region of the removal chamber, and
the end region comprises the removal opening.

12. A method for producing a microfluidic device according to claim 1, comprising:
production of the microfluidic device with the removal opening;
applying the removable cover to the removal opening.

13. The method according to claim 12, wherein the removable cover is an adhesive film.

14. The microfluidic device according to claim 1, wherein the removable cover is an adhesive film.
